(19) United States
(12) Patent Application Publication
(10) Pub. No.: US 2014/0099173 A1
(43) Pub. Date: Apr. 10, 2014

(54) NUT

(71) Applicant: LING-HONG ZENG, Shenzhen City (CN)

(72) Inventor: LING-HONG ZENG, Shenzhen City (CN)

(21) Appl. No.: 13/666,894

(22) Filed: Nov. 1, 2012

(30) Foreign Application Priority Data
Oct. 10, 2012 (CN) 201210381734X

(51) Int. Cl. F16B 37/00

(52) U.S. Cl. 411/427

(57) ABSTRACT

A nut includes a main body. The main body includes a first end and a second end opposite to the first end. The main body defines a central threaded through hole and a receiving access along an axis of the main body. The central threaded through hole communicates with the receiving access and extends along the axis of the main body from the first end. The receiving access extends along the axis of the main body from the second end and includes at least three inner sidewalls.

### BACKGROUND

1. Technical Field

The present disclosure relates to a connecting mechanism and, particularly, to a nut.

2. Description of Related Art

Rotating a spanner to fasten a nut to a bolt or loosen a nut from a bolt usually requires greater operation space, which may bring trouble to fasten or loosen a nut if the operation space is limited.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a nut and a bolt.

FIG. 2 is an assemble view of an embodiment of the nut and the bolt of FIG. 1.

FIG. 3 is similar to FIG. 2, but showing a tool employed to rotate the nut of FIG. 1.

### DETAILED DESCRIPTION

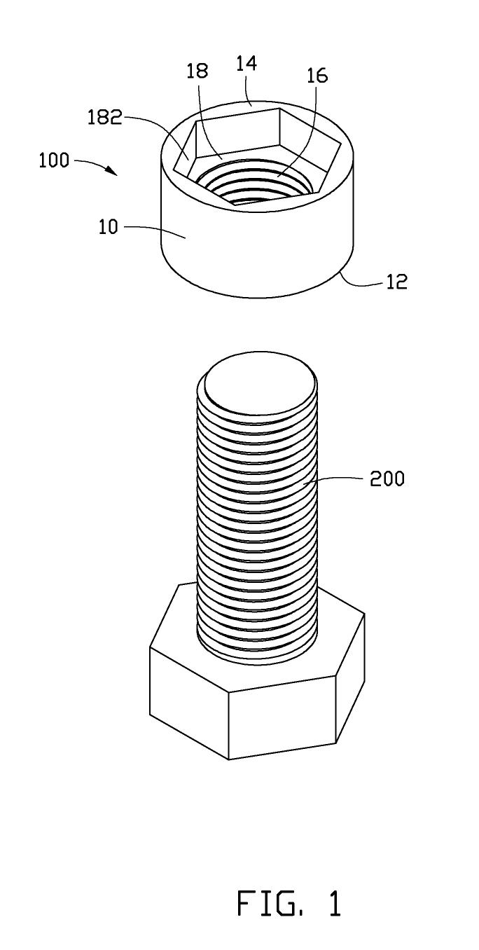

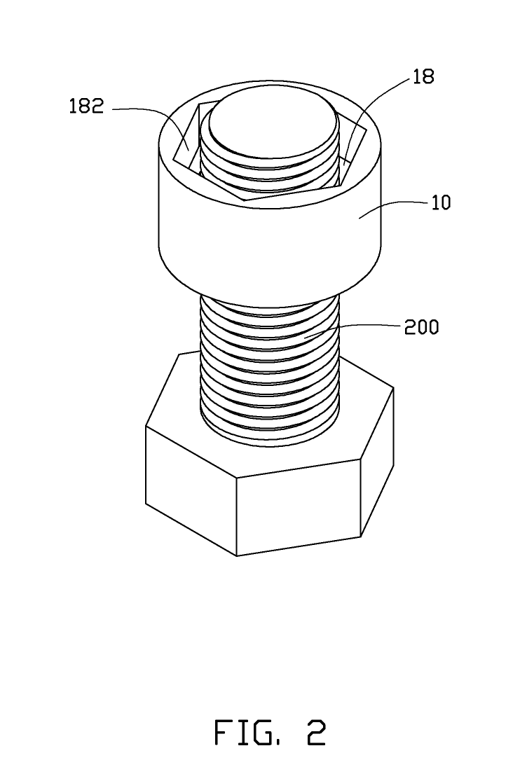

Referring to FIG. 1 and FIG. 2, an embodiment of a nut 100 is illustrated. The nut 100 includes a main body 10. The main body 10 includes a first end 12 and a second end 14 opposite to the first end 12. The main body 10 defines a central threaded through hole 16 in the first end 12 and a receiving access 18 in the second end 14. The central threaded through hole 16 communicates with the receiving access 18 and extends along a central axis of the main body 10. The receiving access 18 extends along the central axis of the main body 10. The receiving access 18 includes at least three inner sidewalls 182. In the embodiment, the receiving access 18 is prism-shaped and has a polygonal cross-section centered on the central axis. In the embodiment, a distance between the central axis and each inner sidewall 182 is greater than a radius of the central threaded through hole 16. In alternative embodiments, the distance between the central axis and each inner sidewall 182 is equal to or less than the radius of the central threaded through hole 16. In the embodiment, the receiving access 18 includes six inner sidewalls 182 which have a same shape and size.

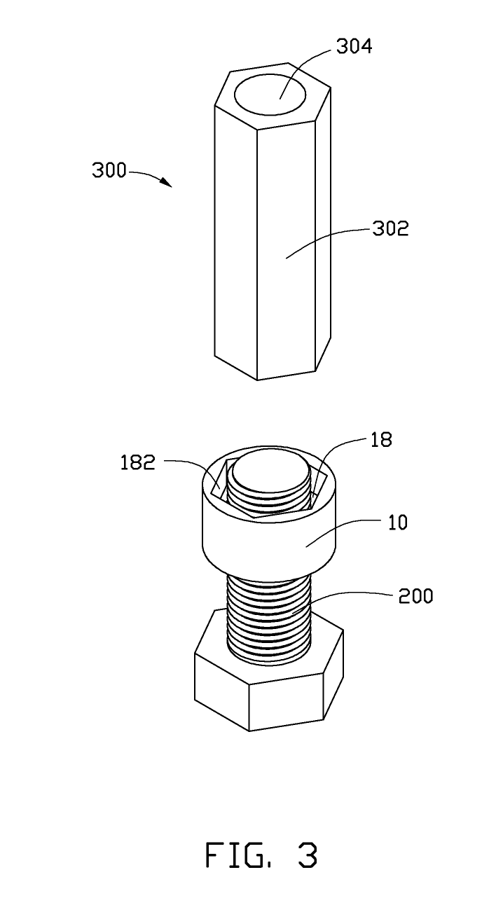

Referring also to FIG. 3, an embodiment of a tool 300 for fastening or loosening the nut 100 is illustrated. The tool 300 includes outer sidewalls 302 and a through hole 304 along a central axis of the tool 300. The number of the outer sidewalls 302 is equal to the number of the inner sidewalls 182. The diameter of the through hole 304 is equal to the diameter of a screw (not labeled) of the bolt 200. When the tool 300 is placed in the receiving access 18, each outer sidewall 302 resists one inner sidewall 182.

When using the tool 300 to fasten or loosen the nut 100, the tool 300 is placed in the receiving access 18, each outer sidewall 302 resists one inner sidewall 182. The tool 300 is then rotated. The friction between the outer sidewalls 302 and the inner sidewall 182 causes the nut 100 to be fastened or loosened.

In alternative embodiments, if the distance between the central axis and each inner sidewall 182 is equal to or less than the radius of the central threaded through hole 16, the through hole 304 can be absent from the tool 300.

For the design of the nut 100 and the tool 300, less space for rotating the tool 300 is required, thus the tool 300 can be conveniently employed to fasten or looses the nut 100.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A nut comprising:
a main body comprising a first end and a second end opposite to the first end, the main body defining a central threaded through hole in the first end and a receiving access in the second end, the central threaded through hole communicating with the receiving access and extending along a central axis of the main body, the receiving access extending along the central axis of the main body and comprising at least three inner sidewalls.

2. The nut as described in claim 1, wherein a distance between the central axis and each of the at least three inner sidewalls is greater than a radius of the central threaded through hole.

3. The nut as described in claim 1, wherein a distance between the central axis and each of the at least three inner sidewalls is equal to a radius of the central threaded through hole.

4. The nut as described in claim 1, wherein a distance between the central axis and each of the at least three inner sidewalls is less than a radius of the central threaded through hole.

5. The nut as described in claim 1, wherein the receiving access comprises six inner sidewalls.

6. The nut as described in claim 5, wherein the six sidewalls have a same shape and size.

7. The nut as described in claim 1, wherein the receiving recess is prism-shaped and has a polygonal cross-section centered on the central axis.
